(19) United States
(12) Patent Application Publication
(10) Pub. No.: US 2005/0227520 A1
(43) Pub. Date: Oct. 13, 2005

(54) Memory card connector

(76) Inventor: Lee-Jen Wu, Taipei (TW)

Correspondence Address: MOLEX INCORPORATED, 2222 WELLINGTON COURT, LISLE, IL, 60532, US

(21) Appl. No.: 11/035,524

(22) Filed: Jan. 14, 2005

(30) Foreign Application Priority Data
Jan. 16, 2004 (TW) 93200919

(51) Int. Cl. H01R 13/62

(52) U.S. Cl. 439/159

(57) ABSTRACT

A memory card connector is provided for receiving different types of memory cards. The connector includes a two-part dielectric housing which defines a card-receiving space or cavity between the housing parts. The two-part housing includes an upper housing part overmolded about portions of a plurality of terminals in a first set thereof having contact portions for engaging a first type of memory card. A lower housing part is overmolded about portions of a plurality of terminals in a second set thereof having contact portions for engaging a second type of memory card. The upper and lower housing parts are joined to define the card-receiving space.

### FIELD OF THE INVENTION

This invention generally relates to the art of electrical connectors and, particularly, to a memory card connector for receiving different types of memory cards.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

Because of developments in the computer and portable electrical appliances, different memory cards are being provided to satisfy different requirements. In order to adapt to the different memory cards, different electrical connectors are provided for electrical connection between different memory cards and the electrical appliances. Typically, one memory card connector usually can read/write only one standard memory card.

In order to accommodate different standard memory cards in a single electrical appliance, and to reduced the operable space and production costs, memory card connectors have been suggested for reading/writing different standard memory cards. In any memory card connector, a plurality of conductive terminal sets are assembled to a housing component of the memory card connector by inserting the terminals into holes in a housing component of the connector. This is true whether the connector receives only one standard memory card or different standard memory cards.

In order to accommodate increasing numbers of terminal sets for increasingly different standard memory cards, the housing component of the connector must be designed with increasing numbers of terminal-receiving holes. For example, a Smart Media (SM) card has 22 read/write terminals and two write protection control terminals. A Memory Stick (MS) card has 10 terminals. A Secured Digital (SD) card has nine terminals. An eXtreme Digital (XD) card has 19 terminals. Compact arrangements of terminal-receiving holes in the connector housing leads to narrow gaps between the terminals, and the housing partitions in the gaps between the terminal-receiving holes are extremely thin and very weak. Therefore, the rigidity of the connector housing is quite fragile and can break after extended use, especially in the spacings between the terminals. These problems are compounded with the ever-increasing miniaturization of electrical appliances and the corresponding memory card connectors.

In addition, inserting conductive terminal sets into the terminal-receiving holes of the connector housing component involves a separate assembly procedure. With the increasing numbers of terminals/terminal sets, this procedure is quite difficult, and maintaining the terminals in a common plane also creates considerable problems.

Still further, the insulative housing components of memory card connectors are fabricated by injection molding procedures which involves considerable forces to inject molten plastic into the housing molds. With the increasing density or numbers of terminals and their very close spacing, as described above, the molten plastic cannot be uniformly injected into the mold, and the structure of the housing component is not uniform and not rigid. The present invention is directed to solving this myriad of problems.

### SUMMARY OF THE INVENTION

An object, therefore, of the invention is to provide a new and improved memory card connector for receiving different types of memory cards.

In the exemplary embodiment of the invention, the connector includes a two-part dielectric housing which defines a card-receiving space or cavity between the housing parts. The two-part housing includes an upper housing part overmolded about portions of a plurality of terminals in a first set thereof having contact portions for engaging a first type of memory card. A lower housing part is overmolded about portions of a plurality of terminals in a second set thereof having contact portions for engaging a second type of memory card. Means are provided for joining the upper and lower housing parts to define the card-receiving space.

As disclosed herein, one of the housing parts is overmolded about portions of a plurality of terminals in a third set thereof having contact portions for engaging a third type of memory card. The one housing part is overmolded about portions of a plurality of terminals in a fourth set thereof having contact portions for engaging a fourth type of memory card. The terminals in the multiple sets thereof are in generally parallel rows.

According to one aspect of the invention, the terminals include solder tail portions for connection to appropriate circuit traces on a printed circuit board. The solder tail portions are generally flush with a board-mounting surface of one of the housing parts. As disclosed herein, the solder tail portions of one of the sets of terminals are located along one side of the housing. The solder tail portions of another set of terminals are located along a rear of the housing.

According to another aspect of the invention, one of the housing parts includes at least one locating post insertable into a locating hole in the other housing part. The joining means comprises an ultrasonic welded joint between the housing parts.

Finally, in the exemplary embodiment, one of the housing parts is overmolded about portions of a pair of write protection control terminals.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top perspective view of a memory card connector according to the invention, with the two housing parts separated;

FIG. 2 is a bottom perspective view similar to that of FIG. 1;

FIG. 3 is a top perspective view of the connector in assembled condition; and

FIG. 4 is a bottom perspective view of the assembled connector, looking at the rear of FIG. 3.

### DETAILED DESCRIPTION OF THE PREFERRED EMBODIMENT

Referring to the drawings in greater detail, the invention is embodied in a memory card connector, generally designated 8, which includes a two-part dielectric housing 10 formed by an upper housing part, generally designated 11, and a lower housing part, generally designated 12. Before proceeding further, it should be understood that such terms as “upper”, “lower”, “top”, “bottom” and the like have been used herein and in the claims hereof to provide a more clear and concise description and understanding of the invention in view of the drawings. Obviously, the connector is omni-directional in use, and such terms are not intended in any way to be limiting.

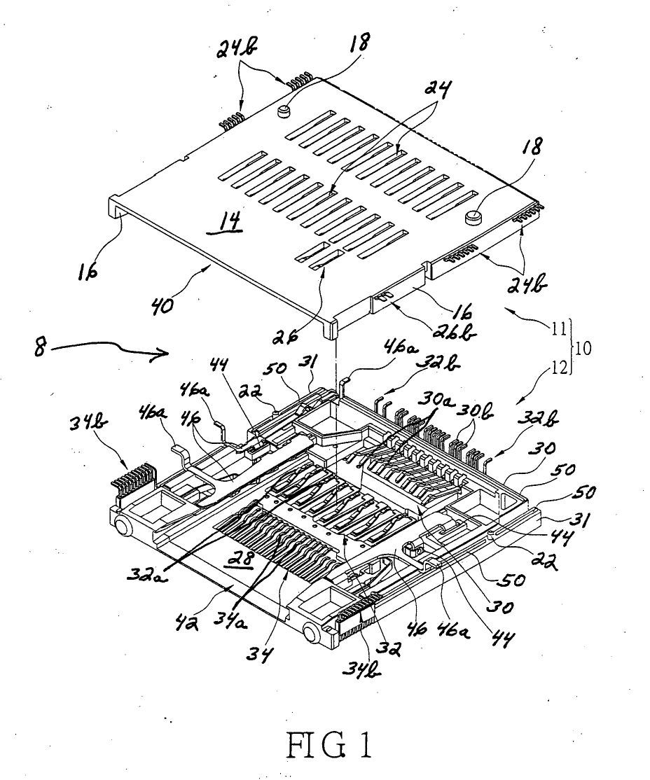

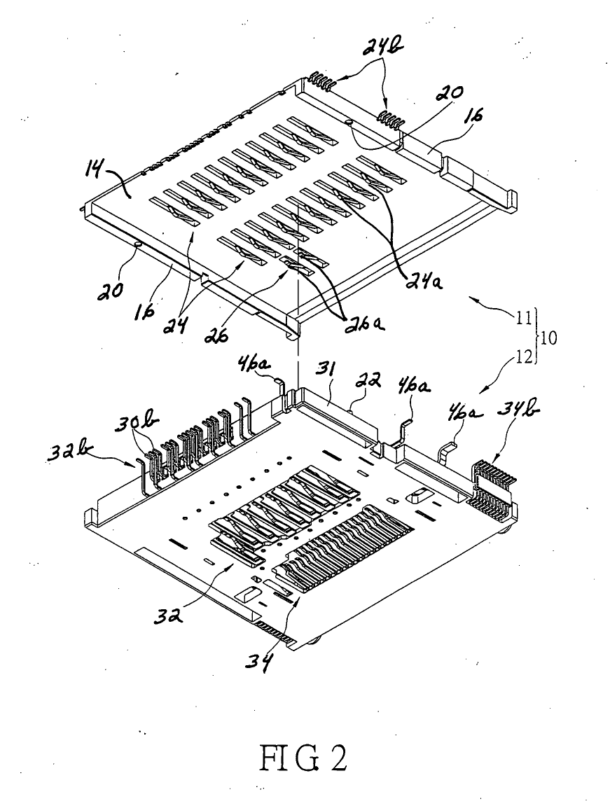

With that understanding, upper housing part 11 includes a top wall 14 and a pair of depending side walls 16. The top wall is flat and includes a pair of board-mounting posts 18 (FIG. 1) projecting therefrom for insertion into an appropriate pair of mounting holes in a printed circuit board (not shown) to mount connector 10 to the board. As seen in FIG. 2, the edges of side walls 16 are provided with a pair of locating holes 20 for receiving a pair of locating posts 22 (FIG. 1) projecting from lower housing part 12.

Upper housing part 11 is a one-piece structure unitarily molded of dielectric material such as plastic or the like. The housing part is overmolded about portions of a plurality of terminals, generally designated 24, in a first set of terminals. Obviously, the portions of the terminals about which upper housing part 11 is overmolded are not visible in the drawings because those portions are rigidly embedded within the plastic material of the housing. However, the overmolding procedure leaves contact portions 24a and solder tail portions 24b of the terminals exposed outside the housing. Contact portions 24a project downwardly from top wall 14 of the upper housing part, as best seen in FIG. 2, for engaging the contacts of a first type of memory card, particularly an SM Smart Media card. As best seen in FIG. 1, solder tail portions 24b of the first set of terminals 24 project outwardly from opposite sides of upper housing part 11, i.e., outwardly of side walls 16 of the upper housing part.

Upper housing part 11 also is overmolded about a pair of write protection control terminals, generally designated 26. Like the first set of terminals 24, the write protection control terminals include contact portions 26a which project downwardly from top wall 14 of upper housing part 11, as seen in FIG. 2, for engagement by the various memory cards. The write protection control terminals include solder tail portions 26b which project outwardly from one of the side walls 16 of the upper housing part as seen in FIG. 1, generally flush with top wall 14, for solder connection to appropriate circuit traces on the printed circuit board.

Like the upper housing part, lower housing part 12 also is a one-piece structure unitarily molded of dielectric material such as plastic or the like. The lower housing part includes a bottom wall 28, a rear wall 30 and a pair of side walls 31. Locating posts 22 project upwardly from the side walls.

Lower housing part 12 is overmolded about three distinct sets of conductive terminals, namely: a second set of terminals, generally designated 30; a third set of terminals, generally designated 32; and a fourth set of terminals, generally designated 34. It can be seen in FIG. 1 that the three sets of terminals 30, 32 and 34 are in generally parallel rows which extend generally transversely of the housing part and connector.

Lower housing part 12 is overmolded about concealed portions of the second set of terminals 30, leaving contact portions 30a and solder tail portions 30b exposed outside the housing. Contact portions 30a project upwardly from bottom wall 28 of the lower housing part. Solder tail portions 30b project rearwardly and upwardly from rear wall 30 of the lower housing part for solder connection to appropriate circuit traces on the printed circuit board. Contact portions 30a of the second set of terminals 30 are adapted for engaging appropriate contacts of an SD (Secured Digital) card.

Lower housing part 12 is overmolded about concealed portions of the third set of terminals 32, leaving contact portions 32a and solder tail portions 32b of the third set of terminals exposed outside the housing. Contact portions 32a project upwardly from bottom wall 28, and solder tail portions 32b project outwardly and upwardly from rear wall 30 of the lower housing part for solder connection to appropriate circuit traces on the printed circuit board. Contact portions 32a of the third set of terminals 32 are adapted for engaging the contacts of an MMC (MultiMedia Card) card.

Lower housing part 12 is overmolded about concealed portions of the fourth set of terminals 34, leaving contact portions 34a and solder tail portions 34b of the fourth set of terminals exposed outside the lower housing part. Solder tail portions 34b extend outwardly and upwardly of side walls 31 for solder connection to appropriate circuit traces on the printed circuit board. Contact portions 34a of the fourth set of terminals project upwardly from bottom wall 28 for engaging appropriate contacts of an XD (eXtreme Digital) card.

Upper housing part 11 has a relatively wide card-receiving space, generally designated 40 (FIG. 1) between side walls 31 for receiving a wider SM memory card. Lower housing part 12 has a narrower card-receiving space 42 between side walls 31 for receiving narrower SD, MMC and XD memory cards. The lower housing part includes a plurality of mounting bosses 44 for mounting a plurality of guide plates 46 which help to separate card-receiving spaces 40 and 42 and to guide the various memory cards into the connector. The guide plates are stamped and formed of metal material and include tail portions 46a for solder connection to appropriate mounting pads on the printed circuit board to rigidify the guide plates.

Upper and lower housing parts 11 and 12, respectively, are assembled by inserting locating posts 22 on the lower housing part into locating holes 20 in the upper housing part. The lower housing part includes a plurality of welding ribs 50 along the tops of side walls 31 and rear wall 30, and the two housing parts are rigidly fixed to each other by an ultrasonic welding procedure which conducts sound waves to welding ribs or lines 50 during the ultrasonic welding process.

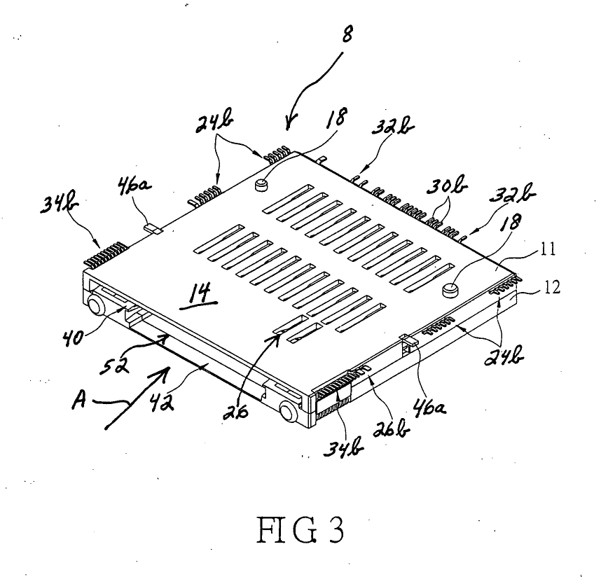

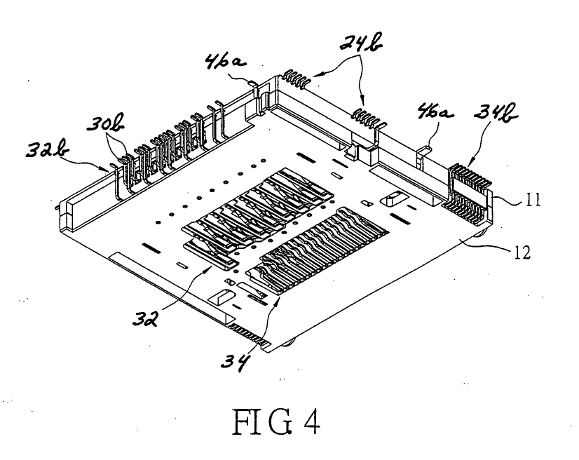

FIGS. 3 and 4 show the two housing parts ultrasonically welded together to form connector 8, with the card-receiving space 40 of upper housing part 11 and card-receiving space 42 of lower housing part 12 forming a composite card-receiving cavity, generally designated 52 (FIG. 3), for receiving the four different types of memory cards inserted into the cavity in the direction of arrow “A”. When assembled, solder tail portions 24b of the first set of terminals, solder tail portions 30b of the second set of terminals, solder tail portions 32b of the third set of terminals, solder tail portions 34b of the fourth set of terminals, solder tail portions 26b of the write protection control terminals and tail portions 46a of the guide plates all are flush with the outside surface of top wall 14 of upper housing part 11 as seen in FIG. 3, for solder connection to appropriate circuit traces and mounting pads on the printed circuit board, with mounting posts 18 projecting from the top of the upper housing part inserted into their respective mounting holes in the printed circuit board.

From the foregoing, it can be understood that the two housing parts 11 and 12 of connector housing 10 do not have any terminal-receiving holes which create narrow gaps between the terminals of the housing and which would reduce the rigidity of the housing structure, along with the life and durability of the connector, itself. In addition, the insertion procedures of the different sets of terminals into holes in the housing are completely eliminated. The housing can be uniformly fabricated by overmolding the housing parts about portions of their respective terminals and increase the structural integrity of the connector housing. With portions of the terminals embedded in the housing parts, other control elements also can be installed with ease.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for receiving different types of memory cards, comprising:
a two-part dielectric housing which at least in part defines a card-receiving space between the housing parts and including
an upper housing part overmolded about portions of a plurality of terminals in a first set thereof having contact portions for engaging a first type of memory card inserted into said card-receiving space, and
a lower housing part overmolded about portions of a plurality of terminals in a second set thereof having contact portions for engaging a second type of memory card inserted into said card-receiving space; and
means for joining the upper and lower housing parts to define the card-receiving space.

2. The memory card connector of claim 1 wherein one of said housing parts is overmolded about portions of a plurality of terminals in a third set thereof having contact portions for engaging a third type of memory card.

3. The memory card connector of claim 2 wherein said one housing parts is overmolded about portions of a plurality of terminals in a fourth set thereof having contact portions for engaging a fourth type of memory card.

4. The memory card connector of claim 3 wherein the terminals in said sets thereof are in generally parallel rows.

5. The memory card connector of claim 1 wherein one of said housing parts is overmolded about portions of a pair of write protection control terminals.

6. The memory card connector of claim 1 wherein said terminals include solder tail portions for connection to appropriate circuit traces on a printed circuit board.

7. The memory card connector of claim 6 wherein said solder tail portions are generally flush with a board-mounting surface of one of the housing parts.

8. The memory card connector of claim 6 wherein the solder tail portions of one of said sets of terminals are located along one side of the housing, and the solder tail portions of another set of terminals are located along a rear of the housing.

9. The memory card connector of claim 1 wherein one of said housing parts includes at least one locating post insertable into a locating hole in the other housing part.

10. The memory card connector of claim 1 wherein said joining means comprises an ultrasonic welded joint between the housing parts.

11. A memory card connector for receiving different types of memory cards, comprising:
a two-part dielectric housing which at least in part defines a card-receiving space between the housing parts and including
an upper housing part overmolded about portions of a plurality of terminals in a first set thereof having contact portions for engaging an SM type memory card inserted into said card-receiving space, and
a lower housing part overmolded about portions of a plurality of terminals in a second set thereof having contact portions for engaging an SD type memory card inserted into said card-receiving space,
said lower housing part being overmolded about portions of a plurality of terminals in a third set thereof having contact portions for engaging an MMC type memory card,
said lower housing part being overmolded about portions of a plurality of terminals in a fourth set thereof having contact portions for engaging an XD type memory card; and
means for joining the upper and lower housing parts to define the card-receiving space.

12. The memory card connector of claim 11 wherein said upper housing part defines a relatively wide portion of the card-receiving space for receiving the SM type memory card, and the lower housing part defines a relatively narrow portion of the card-receiving space for receiving the SD, MMC and XD type memory cards.

13. The memory card connector of claim 12 wherein the terminals in said second, third and fourth sets thereof are in generally parallel rows transversely of the connector.

14. The memory card connector of claim 11 wherein one of said housing parts is overmolded about portions of a pair of write protection control terminals.

15. The memory card connector of claim 11 wherein said terminals include solder tail portions for connection to appropriate circuit traces on a printed circuit board.

16. The memory card connector of claim 11 wherein said solder tail portions are generally flush with a board-mounting surface of one of the housing parts.

17. The memory card connector of claim 15 wherein the solder tail portions of one of said sets of terminals are located along one side of the housing, and the solder tail portions of another set of terminals are located along a rear of the housing.

18. The memory card connector of claim 11 wherein one of said housing parts includes at least one locating post insertable into a locating hole in the other housing part.

19. The memory card connector of claim 11 wherein said joining means comprises an ultrasonic welded joint between the housing parts.
